(19) United States
(12) Patent Application Publication
(10) Pub. No.: US 2023/0087418 A1
(43) Pub. Date: Mar. 23, 2023

(54) ENTANGLEMENT PREVENTION HARNESS FOR BREATHING APPARATUS

(71) Applicant: Philip Andrew Topa, Pelham (CA)

(72) Inventor: Philip Andrew Topa, Pelham (CA)

(21) Appl. No.: 17/448,348

(22) Filed: Sep. 21, 2021

(51) Int. Cl. A62B 35/00; A62B 25/00

(52) U.S. Cl. CPC A62B 35/0025; A62B 25/00

(57) ABSTRACT

A safety harness configured to secure self contained breathing apparatus to a user wherein the safety harness is constructed so as to inhibit entanglement with elements inside a building. The present invention includes a torso mount having a pair of shoulder straps and a belt member that are operably coupled to a back plate. The back plate is configured to have an air tank secured thereto utilizing at least one strap member. A first mounting ring is present and surroundably mounts the air tank proximate the upper end thereof. A first strap member and a second strap member are secured to the first mounting ring and extend to the shoulder strap so as to block a void present between the air tank and back plate. A second mounting ring is present and adjacent to the first mounting ring. A regulator protection member is present around the tank regulator.

### FIELD OF THE INVENTION

The present invention relates generally to safety equipment, more specifically but not by way of limitation, firefighting safety equipment wherein the present invention is directed towards self contained breathing apparatus worn during firefighting that is configured to inhibit entanglement with obstructions present in buildings such as but not limited to wiring.

### BACKGROUND

Firefighters employ a great deal of equipment during the process of eliminating a fire in a structure such as but not limited to a commercial building. While the fire and burning material themselves present significant hazards, there are many other perils that face firefighters when they are deployed inside of a building. During a building fire the structure becomes comprised and many structural and other facility support elements may now be exposed and as such present a significant hazard to the firefighter that is traversing through the building as they are eliminating the fire. These hazards can include but are not limited to structural rebar, electrical wire and plumbing.

The immediately aforementioned building elements can become exposed due to the damage created by the fire. While these elements are not typically exposed in a completed building, their exposure presents a risk to the firefighter. When deployed inside of a building to eliminate a fire, typically a firefighter will wear a self contained breathing apparatus system. This system includes a harness for securing to the firefighter, an air tank, and the appropriate air mask and regulators that facilitate the ability for a firefighter to inhale the air from the tank instead of the building. These breathing rigs are quite cumbersome and have portions thereof that extend away from the back of the wearer. The tank and other portions of these conventional rigs have been known to snag on the aforementioned exposed building elements which can result in the trapping of the firefighter.

Accordingly, there is a need for an entanglement prevention harness that is designed to carry the required breathing apparatus but also be configured so as to inhibit the ability for the equipment to become tangled and/or engage with exposed building elements.

### SUMMARY OF THE INVENTION

It is the object of the present invention to provide an entanglement prevention harness for a self contained breathing apparatus that includes a torso mount operable to secure the present invention to the torso of a wearer.

Another object of the present invention is to provide a safety harness for a self contained breathing apparatus that is operable to inhibit entanglement with elements in a building wherein the present invention includes a first mounting ring secured to the upper portion of the torso mount wherein the first mounting ring extends outward therefrom.

A further object of the present invention is to provide an entanglement prevention harness for a self contained breathing apparatus that includes that includes a second mounting ring wherein the second mounting ring is adjacent and above the first mounting ring and is deployed to facilitate individual rescue.

Still another object of the present invention is to provide a safety harness for a self contained breathing apparatus that is operable to inhibit entanglement with elements in a building that further includes a first strap member and a second strap member wherein the first strap member and second strap member are positioned to inhibit building elements from becoming between the air tank and the torso mount.

An additional object of the present invention is to provide an entanglement prevention harness for a self contained breathing apparatus that further includes a lower mounting member.

Yet a further object of the present invention is to provide a safety harness for a self contained breathing apparatus that is operable to inhibit entanglement with elements in a building wherein the present invention further includes a regulator protection member.

Another object of the present invention is to provide an entanglement prevention harness for a self contained breathing apparatus wherein the second mounting ring is flexible and can be positioned so as to be operably coupled to a safety rope.

Still an additional object of the present invention is to provide a safety harness for a self contained breathing apparatus that is operable to inhibit entanglement with elements in a building wherein the regulator protection member includes a first portion and a second portion positioned on opposing sides of the air regulator on the air tank.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a rear view of the present invention;

FIG. 2 is a side view of the present invention engaged with a user; and

FIG. 3 is a bottom view of the present invention.

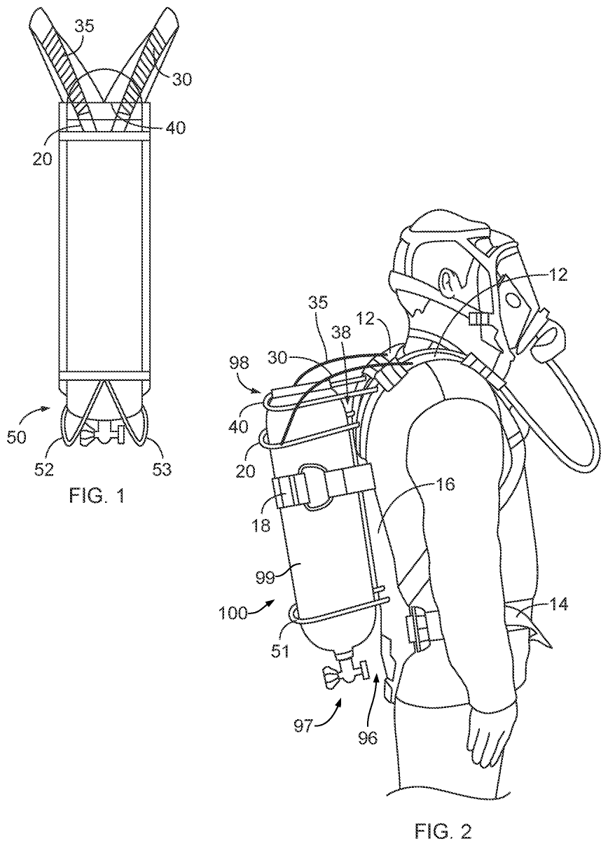

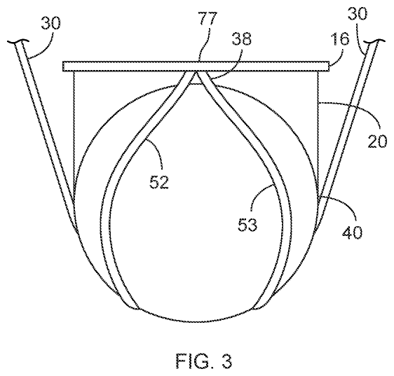

### DETAILED DESCRIPTION

Referring now to the drawings submitted herewith, wherein various elements depicted therein are not necessarily drawn to scale and wherein through the views and figures like elements are referenced with identical reference numerals, there is illustrated an entanglement prevention harness 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular the Figures submitted as a part hereof, the entanglement prevention harness 100 includes a torso mount 10 wherein the torso mount 10 is operable to couple the entanglement prevention harness 100 to a user. The torso mount 10 includes shoulder straps 12, belt member 14 and back plate member 16 wherein the aforementioned are operably coupled utilizing suitable durable techniques. The shoulder straps 12 and belt member 14 are manufactured from a suitable durable material such as but not limited to nylon. Both the shoulder straps 12 and the belt member 14 include fasteners that provide adjustability of the length thereof in order to accommodate users of different sizes. The back plate member 16 is configured to support air tank 99 and is manufactured from a rigid material such as but not limited to plastic. The back plate member 16 is configured to operably secure the air tank 99 thereto utilizing tank strap 18. The tank strap 18 is manufactured from a durable material such as but not limited to nylon and is adjustable so as to accommodate alternate sizes of air tanks 99.

The entanglement prevention harness 100 includes a first mounting ring 20. The first mounting ring 20 is manufactured from a rigid material such as but not limited to metal and is operably coupled to the back plate member 16. The first mounting ring 20 is U-shaped in a preferred embodiment and is shaped so as to be surroundably mounted the air tank 99 providing the ability for removal thereof. The first mounting ring 20 encircles the air tank 99 and provides a structure to secure the first strap member 30 and second strap member 35. The first strap member 30 and second strap member 35 are secured to the first mounting ring 20 on opposing sides thereof so as to be positioned on opposite sides of the air tank 99. The first strap member 30 and second strap member 35 extend from the first mounting ring 20 to the top portion of the shoulder straps 12.

The first strap member 30 and second strap member 35 are secured to the first mounting ring 20 and shoulder straps 12 utilizing suitable durable techniques. The first strap member 30 and second strap member 35 function to inhibit access to the void 38 that is present between the top end 98 of the air tank 99 and the back plate member 16. The void 38 present a hazard during use of conventional equipment similar to the present invention wherein building elements such as but not limited to exposed wire and plumbing can enter the void and result in trapping an individual wearing a traditional system. The first strap member 30 and second strap member 35 provide coverage of the void 38 and as such inhibit an ability for a building element to penetrate therein. It should be understood within the scope of the present invention that the first strap member 30 and second strap member 35 could be manufactured from various different material both rigid an flexible in order to achieve the desired objective stated herein. Furthermore, it is contemplated within the scope of the present invention that the entanglement prevention harness 100 could have a single strap member operable to inhibit access to the void 38.

The second mounting ring 40 is secured to the back plate member 16 and encircles the air tank 99 similar to that of the first mounting ring 20. The second mounting ring 40 is located adjacent to and above the first mounting ring 20 and is secured to the back plate member 16 utilizing suitable durable techniques. The second mounting ring 40 is provided so as to deliver an element to which a safety line can be secured. The second mounting ring 40 functions to provide an element to secure a safety line to a wearer of the entanglement prevention harness 100 wherein in the event the wearer needs assistance in being removed from a building the safety line is anchored to the second mounting ring 40 and the wearer of the entanglement prevention harness 100 can be removed. It is contemplated within the scope of the present invention that the second mounting ring 40 can be flexible and or moveable so as to be placed in a desired position to accept operable coupling with a safety line. It is contemplated within the scope of the present invention that the first mounting ring 20 and second mounting ring 40 could be present as a single element configured to provide the functionality as discussed herein.

The entanglement prevention harness 100 includes a regulator protection member 50. The regulator protection member 50 is configured to inhibit building elements from entering void 96 wherein the void 96 is present between the lower end of the back plate member 16 and the regulator 97. Similar to void 38, void 96 presents a safety concern and as such elements must be controlled from entering thereinto. The regulator protection member 50 includes a lower mounting ring member 51, a first lateral member 52 and a second lateral member 53. The lower mounting ring member 51 is secured to the back plate member 16 utilizing suitable techniques. The lower mounting ring member 51 surroundably mounts the air tank 99 having a void so as to allow the air tank 99 to be positioned therewithin. The first lateral member 52 and second lateral member 53 are secured at one end to the lower mounting ring 51 and extend upward and are secured at opposing ends to the back plate member 16 (not particularly illustrated herein). The arrangement of the first lateral member 52 and second lateral member 53 are to inhibit penetration of any building element into void 96. First lateral member 52 and second lateral member 53 join at point 77 on back plate 16. This prevents potential trapping of a wearer of the entanglement prevention harness 100. While a first lateral member 52 and second lateral member 53 are illustrated and discussed herein, it is contemplated within the scope of the present invention that the entanglement prevention harness 100 could employ either a single lateral member or more than two lateral members arranged in alternate manners so as to provide blockage of void 96.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A harness to secure a self contained breathing apparatus to a user wherein the harness comprises:
a torso mount, said torso mount having a pair of shoulder straps, said torso mount further including a belt member, said torso mount having a back plate member configured to be operably coupled to an air tank, said pair of shoulder straps and belt member being operably secured to said back plate member;
a first mounting ring, said first mounting ring being secured to said back plate member, said first mounting ring configured to encircle the air tank, said first mounting ring extending outward from said back plate;
at least one strap member, said at least one strap member having a first end and a second end, said first end of said at least one strap member being secured to said first mounting ring, said second end of said at least one strap member being secured to one of said pair of shoulder straps, said at least one strap member extending between said first mounting ring and said pair of shoulder straps so as to block a void present between the air tank and said back plate member.

2. The harness to secure a self contained breathing apparatus to a user as recited in claim 1, and further including a second mounting ring, said second mounting ring being adjacent to said first mounting ring, said second mounting ring being secured to said back plate member and configured to encircle the air tank, said second mounting ring operable to have a safety line secured thereto.

3. The harness to secure a self contained breathing apparatus to a user as recited in claim 2, and further including a regulator protection member, said regulator protection member being located proximate a regulator on the air tank, said regulator protection member configured to block a void present between the regulator and the back plate member.

4. The harness to secure a self contained breathing apparatus to a user as recited in claim 3, wherein said regulator protection member further includes a lower mounting ring, said lower mounting ring operably couple to said back plate member and configured to encircle the air tank.

5. The harness to secure a self contained breathing apparatus to a user as recited in claim 4, wherein the regulator protection member further includes at least one lateral member, said at least one lateral member having a first end and a second end, said first end of said at least one lateral member being secured to said lower mounting ring, said second end being secured to back plate, said at least one lateral member operable to block the void between said tank and said back plate member adjacent the regulator.

6. The harness to secure a self contained breathing apparatus to a user as recited in claim 5, wherein said second mounting ring is movable between a plurality of positions.

7. A safety harness to secure a self contained breathing apparatus that is configured to inhibit entanglement with exposed elements within a building wherein thesafety harness comprises:
a torso mount, said torso mount having a pair of shoulder straps, said torso mount further including a belt member, said torso mount having a back plate member configured to be operably coupled to an air tank, said back plate member having an upper end and a lower end, said pair of shoulder straps being secured to said upper end of said back plate member, said belt member being operably secured to said lower end of said back plate member;
a first mounting ring, said first mounting ring being secured to said back plate member, said first mounting ring configured to encircle the air tank, said first mounting ring extending outward from said back plate, said first mounting ring being manufactured from a rigid material;
a first strap member and a second strap member, said first strap member and a second strap member having a first end and a second end, said first end of said first strap member being secured to a first side of said first mounting ring, said first end of said second strap member being secured to a second side of said first mounting ring, said second end of said first strap member being secured to one of said pair of shoulder straps, said second end of said second strap member being secured to one of said pair of shoulder straps, said first strap member and a second strap member extending between said first mounting ring and said pair of shoulder straps so as to block a void present between the air tank and said back plate member; and
a second mounting ring, said second mounting ring being adjacent to said first mounting ring, said second mounting ring being located above said first mounting ring, said second mounting ring being secured to said back plate member and configured to encircle the air tank, said second mounting ring operable to have a safety line secured thereto.

8. The safety harness to secure a self contained breathing apparatus that is configured to inhibit entanglement with exposed elements within a building as recited in claim 7, and further including a regulator protection member, said regulator protection member being proximate said lower end of said back plate member, said regulator protection member operable to cover a regulator on the air tank.

9. The safety harness to secure a self contained breathing apparatus that is configured to inhibit entanglement with exposed elements within a building as recited in claim 8, wherein the regulator protection member includes a lower mounting ring, said lower mounting ring operably coupled to said back plate member, said lower mounting ring being configured to encircle the air tank proximate a lower end thereof.

10. The safety harness to secure a self contained breathing apparatus that is configured to inhibit entanglement with exposed elements within a building as recited in claim 9, wherein said regulator protection member further includes a first lateral member, said first lateral member having a first end and a second end, said first lateral member extending from said lower mounting ring to said back plate member so as to block a void present between the lower end of the air tank and the lower end of the back plate member.

11. The safety harness to secure a self contained breathing apparatus that is configured to inhibit entanglement with exposed elements within a building as recited in claim 10, wherein said regulator protection member further includes a second lateral member, said second lateral member having a first end and a second end, said second lateral member extending from said lower mounting ring to said back plate member on an opposing side with respect to said first lateral member so as to block the void present between the lower end of the air tank and the lower end of the back plate member.

12. The safety harness to secure a self contained breathing apparatus that is configured to inhibit entanglement with exposed elements within a building as recited in claim 11, wherein said first strap member and said second strap member are manufactured from nylon.

13. The safety harness to secure a self contained breathing apparatus that is configured to inhibit entanglement with exposed elements within a building as recited in claim 12, wherein said regulator protection member is manufactured from metal.

14. The safety harness to secure a self contained breathing apparatus that is configured to inhibit entanglement with exposed elements within a building as recited in claim 13, wherein said second mounting ring is flexible so as to be movable to a plurality of alternate positions.
